(19) United States
(12) Patent Application Publication
(10) Pub. No.: US 2025/0175057 A1
(43) Pub. Date: May 29, 2025

(54) HUB DRIVE STRUCTURE

(71) Applicant: LI-HO YAO, Taipei City (TW)

(72) Inventors: LI-HO YAO, Taipei City (TW); Pei-Sheng HSIEH, Taipei City (TW)

(21) Appl. No.: 18/955,898

(22) Filed: Nov. 21, 2024

(30) Foreign Application Priority Data
Nov. 27, 2023 (TW) 112145862

(51) Int. Cl. H02K 7/116; B62M 6/65; H02K 7/08

(52) U.S. Cl. CPC H02K 7/116; B62M 6/65; H02K 7/083

(57) ABSTRACT

A hub drive structure includes an electric machine set, a gear set, an outer rotor input set, and a hub mounted on a hub shaft. The electric machine set includes an internal hood that is fixed through a shaft tube arm to the hub shaft, so that when a motor is supplied with electrical power to operate a rotor to drive the hub, a firm and sound supporting force is obtained to effectively increase the initial driving force of the hub and thus reduce unnecessary kinetic loss, and further, the rotor of the electric machine set and the gear set are coaxially mounted on an output sleeve of the electric machine set to effectively ensure concentricity of the gear set to thereby improve the operation stability thereof and reduce the phenomenon of jitter noise.

### BACKGROUND OF THE INVENTION

### (a) Technical Field of the Invention

The present invention relates to the technical field of hubs of electric vehicles, and more particularly to a hub drive structure including a driving motor, in which a stator of the motor is fixed through an internal hood to a hub shaft, so that when the motor is supplied with electrical power to operate a rotor to drive a hub, a firm and sound supporting force is obtained to effectively increase the initial driving force thereof and thus reduce unnecessary kinetic loss.

### (b) Description of the Prior Art

Hub motors of electric power-assisted bicycles are divided into inner rotor type and outer rotor type, in which the inner rotor hub motor has the stator located at an outer side that is close to the hub housing, so that thermal heat energy of the coil is easier to dissipate to the outside, while the rotor is located at an inner side that is close to the hub shaft, so as to present an advantage of small moment of inertia and easy driving.

The manufacturers have developed a variety of inner rotor hub motors for electric-assisted bicycles, such as Taiwan Patent No. 1455850 on “Bicycle Hub with Internally Arranged Motor”, Taiwan Patent No. 1680908 on “Electric Drive Hub System for Vehicles and Vehicle Including the System”, and Taiwan Patent No. 1770780 on “Inner Rotor Type Hub Motor”. In view of the design of the existing hub motors, when the motor is being driven by supplying electrical power thereto, as the orientation of the stator is not stable, it is not possible to obtain effective supporting force so as to cause unnecessary kinetic loss and reducing the initial driving force of the hub. Further, the concentricity of the reduction gear set is poor, making it easy to generate jitter noise during driving and affecting the stability of operation. In addition, under the requirement of high reduction ratio, it also makes the hub set larger and heavier, increasing the load on the rider.

In other words, due to the imperfectness of the structural design of the existing hub drive structure, there are problems of insufficient supporting force and insufficient concentricity, resulting in issues of kinetic loss and noise, and there are also situations of being bulky and easy to damage under the requirement of high reduction ratio. Thu, further improvements are needed. This is also what the present invention intends to explore.

### SUMMARY OF THE INVENTION

Thus, the primary objective of the present invention is to provide a hub drive structure, in which a stator of a motor is fixed through an internal hood to a hub shaft, so that when the motor is supplied with electrical power to operate a rotor to drive a hub, a firm and sound supporting force is obtained to effectively increase the initial driving force of the hub and thus reduce unnecessary kinetic loss.

A secondary objective of the present invention is to provide a hub drive structure, which effectively ensures the concentricity of a gear set of a hub, in order to improve the operation stability thereof to reduce problems of jitter noise and to further reduce the volume of the hub through the gear set.

### BRIEF DESCRIPTION OF THE DRAWINGS

FIG. 1 is a perspective view of the present invention.

FIG. 2 is a perspective view of the present invention taken from another viewing angle.

FIG. 3 is an exploded view of the present invention, illustrating configurations of and relative relationships among primary components.

FIG. 4 is an exploded view showing a gear set of the structure of the present invention.

FIG. 5 is an exploded view showing an inner rotor one-way bearing of the structure of the present invention.

FIG. 6 is a lateral-side cross-sectional view of the present invention, illustrating the relative relationships among the primary components in an assembled condition.

FIG. 7 is an end-side cross-sectional view of the present invention taken along line A-A of FIG. 6.

FIG. 8 is an end-side cross-sectional view of the present invention taken along line B-B of FIG. 6.

FIG. 9 is an end-side cross-sectional view of the present invention taken along line C-C of FIG. 6, illustrating the configuration of electric-assisted output transmission of the inner rotor one-way bearing.

FIG. 10 is another end-side cross-sectional view of the present invention taken along line C-C of FIG. 6, illustrating the configuration of man-power output idle rotation of the inner rotor one-way bearing.

FIG. 11 is a partial exploded view showing the present invention applied to a frame of an electric-assisted bicycle.

FIG. 12 is a partial perspective view showing the present invention applied to a frame of an electric-assisted bicycle.

FIG. 13 is a partial lateral-side cross-sectional view showing the present invention applied to a frame of an electric-assisted bicycle.

### DETAILED DESCRIPTION OF THE PREFERRED EMBODIMENTS

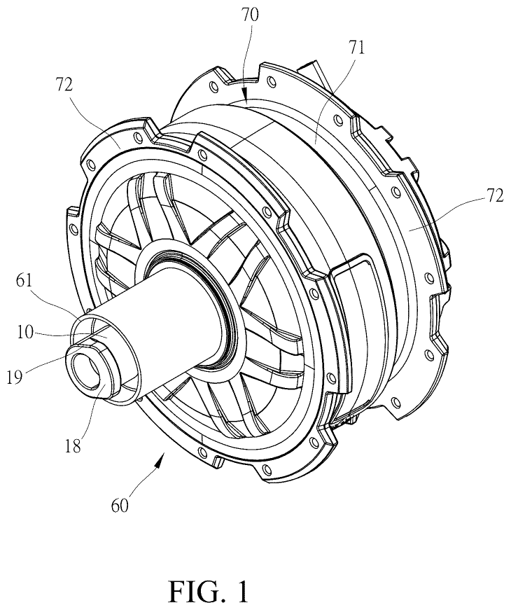

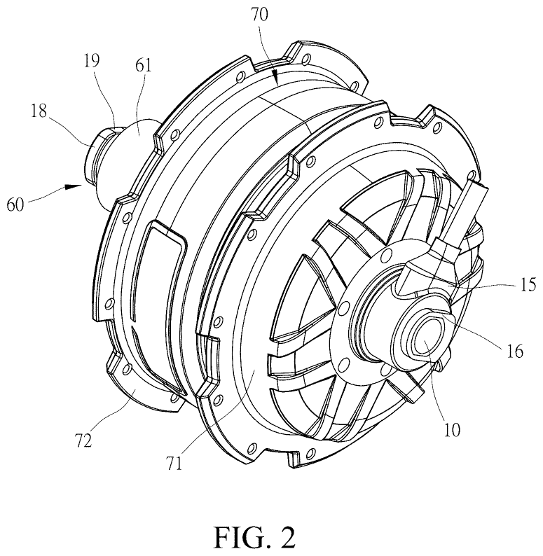

A hub drive structure according to the present invention is used to drive an electric-assisted bicycle or electric vehicle, and as shown in FIGS. 1, 2, and 3, is formed by arranging an electric machine set 20, a gear set 300, an outer rotor input set 60, and a hub 70 on a hub shaft 10.

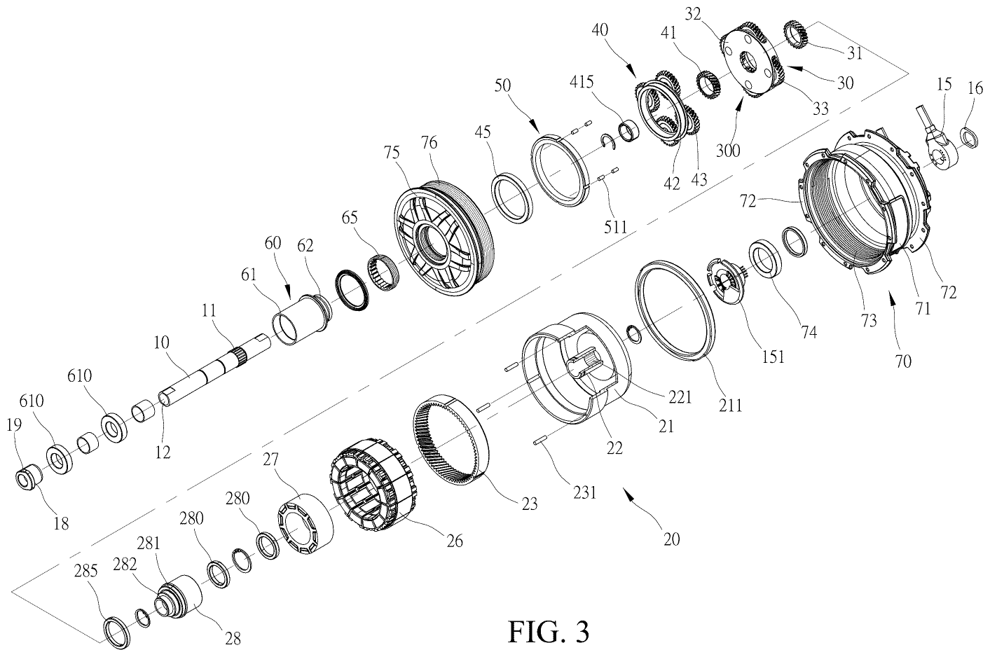

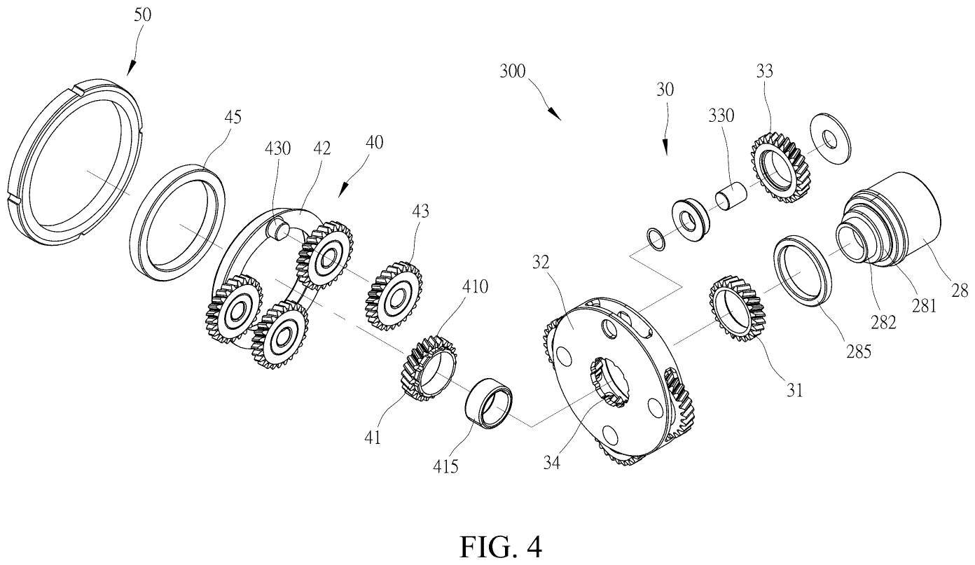

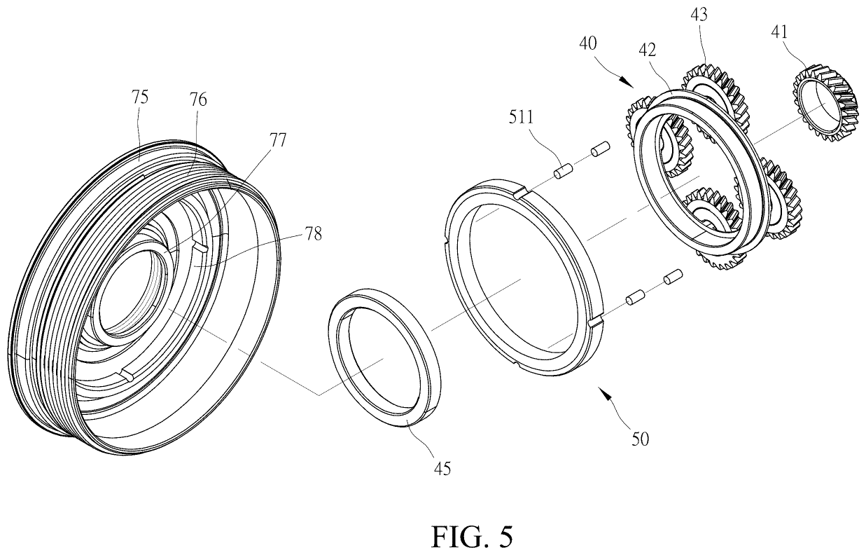

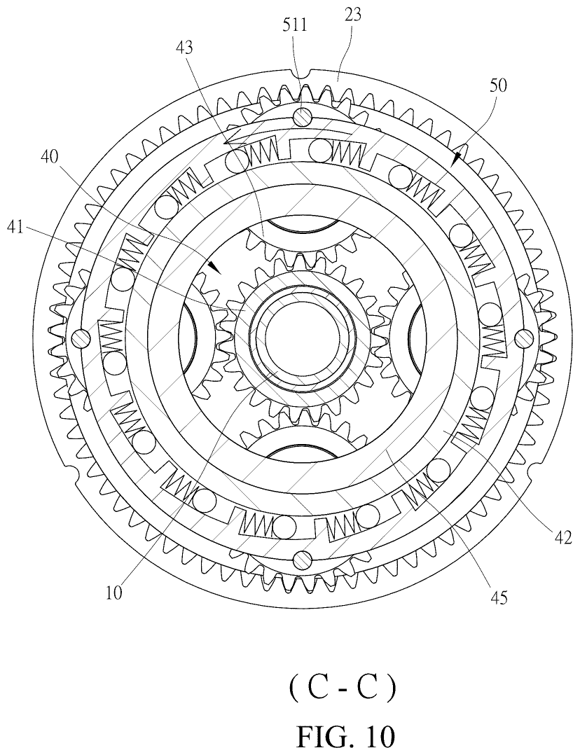

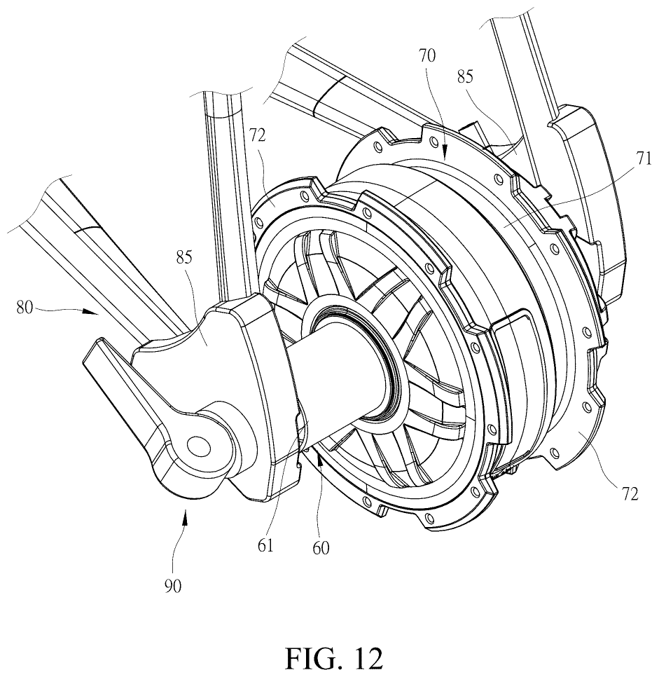

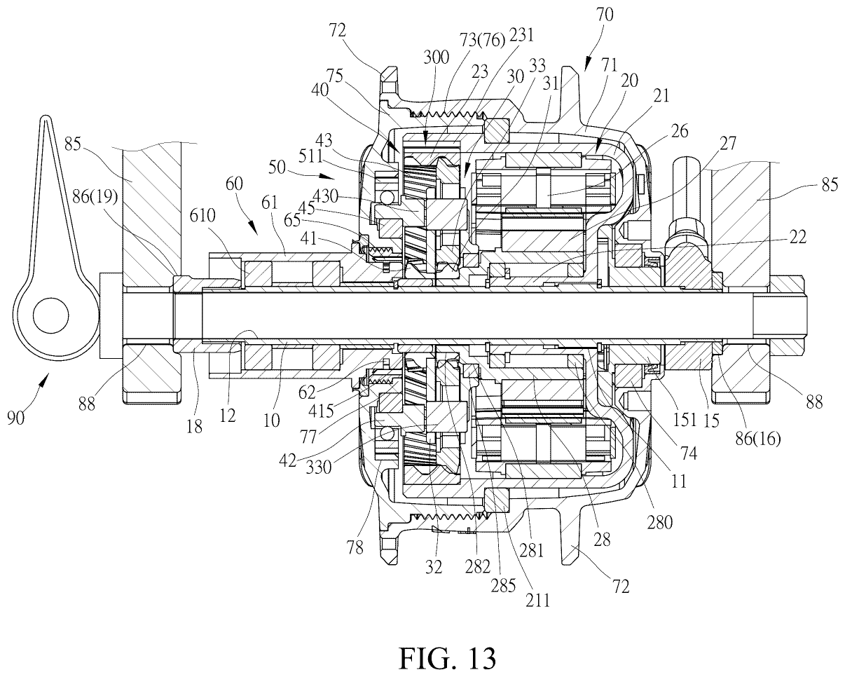

A detailed structure of the hub drive structure according to a preferred embodiment is shown in FIGS. 3, 4, 5, and 6. Two ends of the hub shaft 10 are structured for fixedly mounting on a frame 80 of the electric-assisted bicycle or electric vehicle (see FIGS. 10-13) and to receive the electric machine set 20, the gear set 300, the outer rotor input set 60, and the hub 70 to coaxially mount thereon to drive a wheel (not shown in the drawings) mounted on the hub 70. A circumference of the hub shaft is formed with a toothed section 11 that is formed of a plurality of axial toothed ribs to receive the electric machine set 20 to fixedly mount thereto. The hub shaft 10 comprises a center bore 12 that extends axially to combine with a quick-release axle 90 for mounting to the frame 80.

The electric machine set 20 comprises an internal hood 21 in the form of a cup or bowl. The internal hood 21 has a closed end of which an outer circumference is rotatably mounted by means of a first bearing 211 on an internal circumference of the hub 70, and the closed end of the internal hood 21 is formed, in a center thereof, with a shaft tube arm 22 that extends toward an open end. The shaft tube arm 22 is provided, on an internal circumference thereof, with an internal-hole toothed section 221 corresponding to the toothed section 11 of the hub shaft 10, so that the internal hood 21 is set in matting with and thus fixedly mounted by means of the shaft tube arm 22 to the hub shaft 10. Further, an internal circumference of an open end of the internal hood 21 is fixedly mounted with an internal toothed ring 23 by means of a plurality of first key pins 231. The internal toothed ring 23 mates and engages with the gear set 300. Further, the hub shaft 10 is provided with an output sleeve 28 rotatably mounted on the shaft tube arm 22 of the internal hood 21 by means of a plurality of second bearings 280, so that the output sleeve 28 is freely rotatable relative to the shaft tube arm 22. The electric machine set 20 comprises a stator 26 formed of coils and a rotor 27 formed of magnets arranged between the internal circumference of the internal hood 21 and the external circumference of the output sleeve 28, so that after being supplied with electrical power, the stator 26 that is fixed to the internal hood 21 drives, through electromagnetic induction, the rotor 27 to drive the output sleeve 28 to rotate at a high speed. Further, one end of the output sleeve 28 is formed with a shaft seat step 281 and a diameter-reduced wheel seat step 282, wherein the shaft seat step 281 is combined with a third bearing 285 to rotate relative to the gear set 300, and the wheel seat step 282 is provided for assembling with and driving the gear set 300.

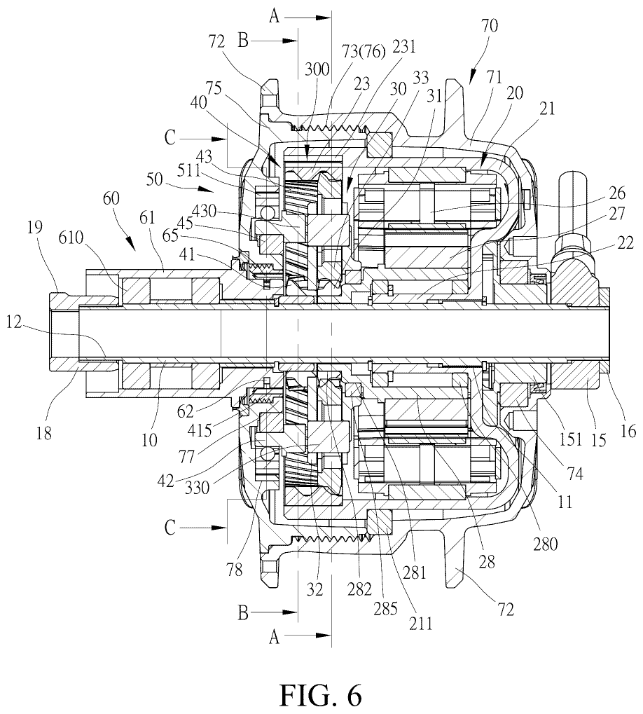

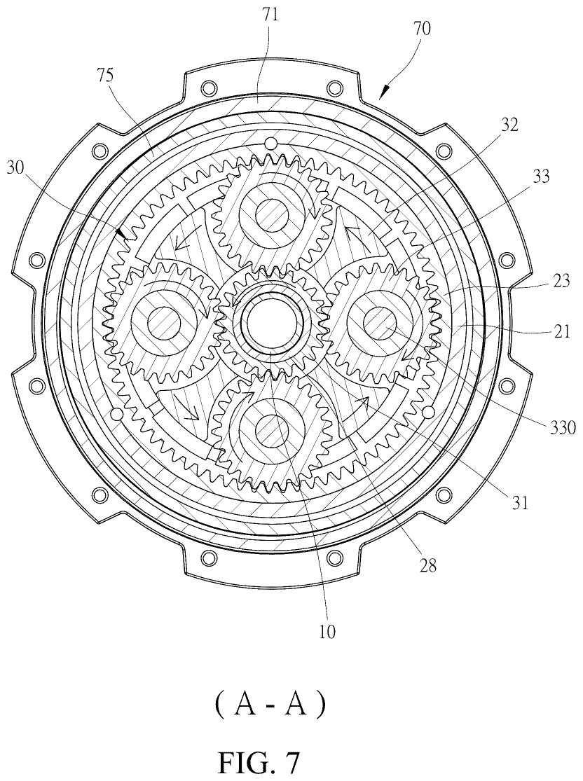

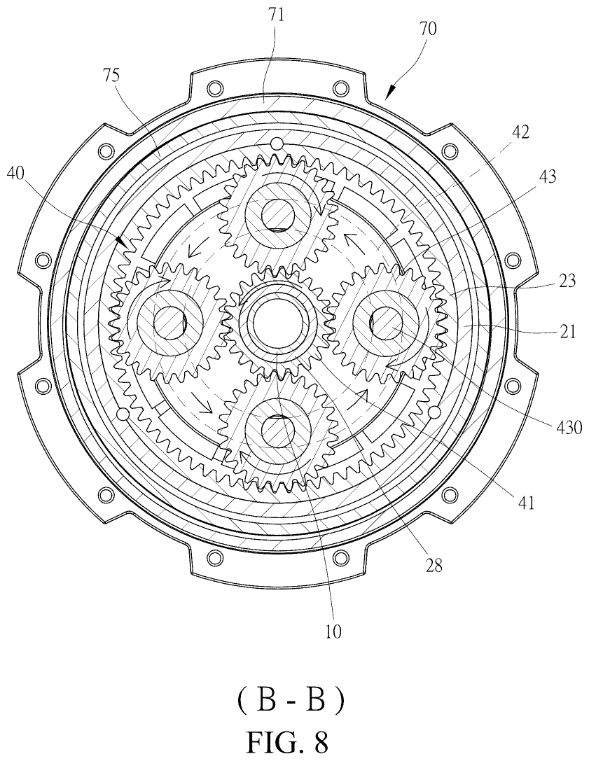

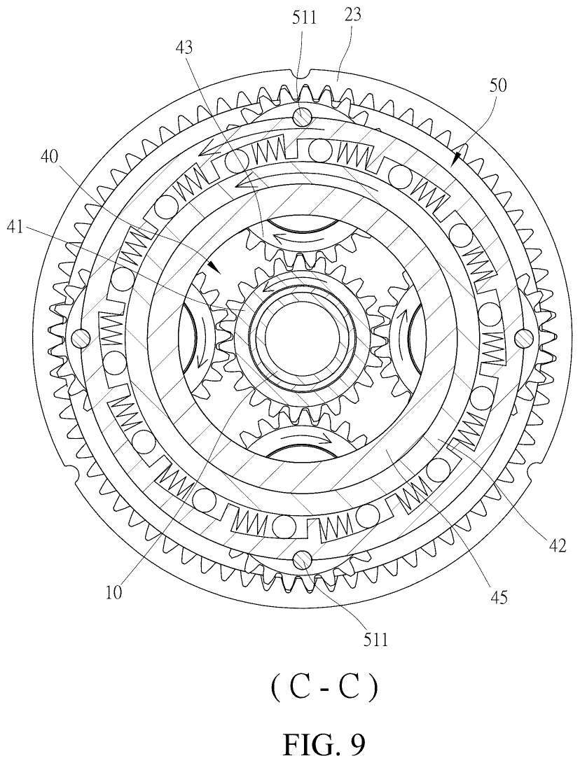

Further, the gear set 300 is arranged at one end of the output sleeve 28 of the electric machine set 20. The gear set 300 comprises a first planetary gear set 30 and a second planetary gear set 40, wherein the first planetary gear set 30 comprises a first sun gear 31 mounted on the wheel seat step 282 of the output sleeve 28. The first sun gear 31 is provided with a plurality of first planet gears 33 surrounding and mating with a circumference thereof (as shown in FIG. 7), and each of the first planet gears 33 is rotatably mounted through a first axle 330 on a first planetary carrier frame 32. Further, each of the first planet gears 33 that is rotatably mounted on the first planetary carrier frame 32 synchronously mates and engages with the internal toothed ring 23 of the internal hood 21 (as shown in FIG. 7), so that the first sun gear 31 drives, through the first planet gears 33, the first planetary carrier frame 32 to rotate. The first planetary carrier frame 32 is mounted on the third bearing 285 of the output sleeve 28, so as to allow the first planetary gear set 30 operate in a manner of being coaxial with the electric machine set 20. Further, a surface of one side of the first planetary carrier frame 32 that is opposite to the electric machine set 20 is formed, in the center thereof, with a mounting toothed hole 34 for mounting the second planetary gear set 40. The second planetary gear set 40 comprises a second sun gear 41 mounted on the first planetary carrier frame 32, wherein the second sun gear 41 comprises a mounting toothed ring 410 corresponding to the mounting toothed hole 34 of the first planetary carrier frame 32. The second sun gear 41 is rotatably mounted by a bearing 415 on the hub shaft 10. The second sun gear 41 is provided with a plurality of second planet gears 43 surrounding and mating with a circumference thereof (as shown in FIG. 8). Each of the second planet gears 43 is rotatably mounted through a second axle 430 on one side of a second planetary carrier frame 42. Further, each of the second planet gears 43 that is rotatably mounted on the second planetary carrier frame 42 synchronously mates and engages with the internal toothed ring 23 of the internal hood 21 (as shown in FIG. 8), so that the second sun gear 41 drives, through the second planet gears 43, the second planetary carrier frame 42 to rotate. The internal circumference of the second planetary carrier frame 42 is mounted through a fourth bearing 45 on the hub 70, so as to further allow the gear set 300 formed of the first planetary gear set 30 and the second planetary gear set 40 to operate in a manner of being coaxial with the electric machine set 20. Further, the external circumference of the second planetary carrier frame 42 is mounted with an inner rotor one-way bearing 50, wherein the external circumference of the inner rotor one-way bearing 50 is fixedly mounted by means of a plurality of second key pins 511 to the internal circumference of the hub 70 (as shown in FIGS. 6 and 9), in order to allow the electric machine set 20 that is arranged inside to drive, in a one way manner after being speed reduced, through the gear set 300, the hub 70 to rotate in an advancing direction of the electric-assisted bicycle, while idling in a reversed direction.

Further, the outer rotor input set 60 comprises an input sleeve 61 rotatably mounted through a plurality of fifth bearings 610 on the hub shaft 10. One end of the input sleeve 61 that corresponds to the hub 70 comprises a raised toothed coupling portion 62 formed of a plurality of axial toothed ribs for engaging with an outer rotor one-way bearing 65 correspondingly assembled and arranged on the hub 70 to allow external man power to drive, in a one way manner, through the input sleeve 61, the hub 70 to rotate toward an advancing direction of the electric-assisted bicycle, while idling in a reversed direction. The end of the hub shaft 10 is fastened with a retaining nut 18 at an outer side of the fifth bearings 610 (as shown in FIG. 6), to fasten and position the outer rotor input set 60 on the hub shaft 10. A second mounting block 19 is formed on an outer side of the retaining nut 18 to mount the hub shaft 10 on the frame 80.

The hub 70 is formed of a first hub casing 71 and a second hub casing 75 that are located on two sides of the hub shaft 10 and combinable with and closable with each other in an opposite manner. The first and second hub casings 71, 75 are respectively provided with locking portions 73, 76 that are combinable with each other. The locking portions 73, 76 can be corresponding internal and external threaded portions or a threaded hole and a bolt for protecting and supporting the electric machine set 20 and the gear set 300. Two sides of an external circumference of at least one of the first and second hub casings 71, 75 are provided with spoke mounting portions 72 for mounting bicycle rim spokes. The center of the first hub casing 71 is rotatably mounted through a sixth bearing 74 on a coupling device 151 fixedly mounted to the hub shaft 10 to allow the first hub casing 71 to rotate relative to the hub shaft 10. The end of the hub shaft 10 is provided with an electric connector 15 connected to the coupling device 151, and an end face of the electric connector 15 that faces outwards is provided with a first mounting block 16 for assembling with and mounting to the frame 80. The electric connector 15 functions to supply electrical power to the electric machine set 20 inside the hub 70. The internal circumference of the second hub casing 75 is provided with a bearing mounting portion 78 corresponding to the inner rotor one-way bearing 50 of the gear set 300. The second hub casing 75 is provided, on the center thereof, with a central projection 77 that receives the fourth bearing 45 of the gear set 300 to mount on an external circumference thereof. The internal circumference of the central projection 77 receives the outer rotor one-way bearing 65 of the outer rotor input set 60 to fasten thereto.

As such, a hub drive structure that provides an initial supporting force for driving and has high concentricity is formed.

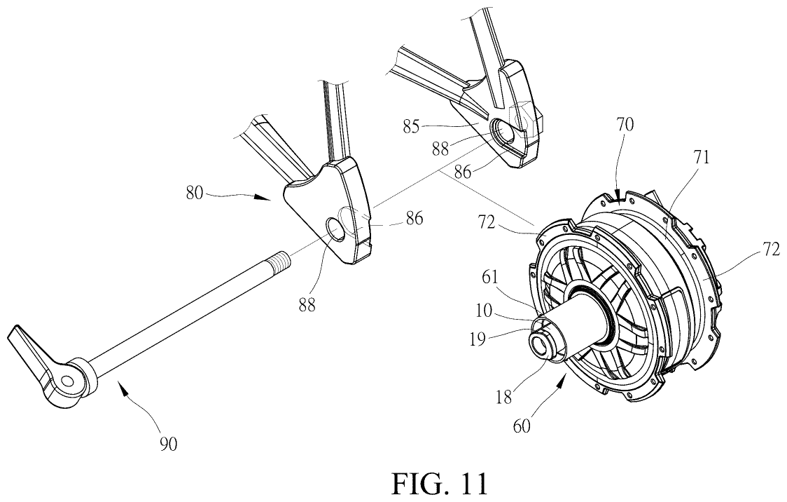

A practical operation of the present invention the hub drive structure is illustrated in FIGS. 11-13. The hub shaft 10 is mounted through a quick-release axle 90 between two wheel bifurcation bars 85 of the frame 80 of the electric-assisted bicycle or the electric vehicle, and the electric connector 15 of the hub shaft 10 is connectable to a controller (not shown in the drawings). The outer rotor input set 60 of the hub shaft 10 receives a sprocket wheel (not shown in the drawings to mount thereto. The bifurcation bars 85 on the two sides of the frame 80 having opposite surfaces that are each formed with a mounting trough 86 having an opening facing outwards. The mounting troughs 86 on the two sides are formed with through holes 88 corresponding to each other, so that the hub drive structure may be arranged to have the first and second mounting blocks 16, 19 at the outer side of the electric connector 15 and provided on the retaining nut 18, which are respectively at the two ends of the hub shaft 10, respectively inserted into the opposite mounting troughs 86 of the bifurcation bars 85 on two sides of the frame 80, in combination with the quick-release axle 90 penetrating through the through hole 88 of the bifurcation bar 85 of one side, the center bore 12 of the hub shaft 10, and the through hole 88 of the bifurcation bars 85 of another side, to thereby have the hub drive structure quickly and securely mounted between the bifurcation bars 85 of two sides of the frame 80.

To operate, when it needs to drive the bicycle with electric assisting, as shown in FIGS. 6-10, electrical power is supplied to the electric machine set 20, so that the stator 26 of the electric machine set 20 that is fixed to the internal hood 21 generates magnetic induction on the rotor 27 that is mounted on the output sleeve 28 to have the rotor 27 of the electric machine set 20 driving the output sleeve 28 to rotate at a high speed, and as shown in FIG. 7, the output sleeve 28 drives the first sun gear 31 of the first planetary gear set 30 of the gear set 300 to rotate counterclockwise in the advancing direction of the electric-assisted bicycle to thereby drive the first planet gears 33 of the first planetary gear set 30 to rotate clockwise. As the first planet gears 33 synchronously mate with the internal circumference of the internal toothed ring 23 that is mounted to the internal hood 21, the first planetary carrier frame 32 is caused to rotate counterclockwise in a speed reduced manner as being operated by means of the gear ratio between the first sun gear 31 and the first planet gears 33.

Next, as shown in FIG. 8, as the second sun gear 41 of the second planetary gear set 40 is fixed on the first planetary carrier frame 32, the second sun gear 41 is caused to synchronously rotate counterclockwise to thereby drive the second planet gears 43 of the second planetary gear set 40 to rotate clockwise. As the second planet gears 43 synchronously mate with the internal circumference of the internal toothed ring 23 of the internal hood 21, the second planetary carrier frame 42 is caused to rotate clockwise in a speed reduced manner as being operated by means of the gear ratio between the second sun gear 41 and the second planet gears 43, and further, as shown in FIG. 9, driving the inner rotor one-way bearing 50 mounted on the second planetary carrier frame 42 to drive the second hub casing 75 of the hub 70 to have the hub 70 rotating counterclockwise to achieve the purpose of driving the electric-assisted bicycle to advance forward, and further, under this condition, the outer rotor one-way bearing 65 between the second hub casing 75 and the input sleeve 61 is in an idling state, preventing man power and the transmission power of the electric machine set 20 from interfering with each other.

Further, when it needs to drive the electric-assisted bicycle with man power, this can be done by directly stepping the crank to make the chain drive the sprocket wheel (not shown in the drawings) mounted on the input sleeve 61 of the outer rotor input set 60. The input sleeve 61 drives, through the outer rotor one-way bearing 65, the second hub casing 75 to rotate in the advancing direction of the electric-assisted bicycle, making the hub 70 rotating to advance thereby achieving the purpose of man power driving the electric-assisted bicycle to advance, and further, under this condition, the inner rotor one-way bearing 50 between the second hub casing 75 and the second planetary carrier frame 42 of the second planetary gear set 40 is in an idling state (as shown in FIG. 10) to prevent the transmission power of the electric machine set 20 and the man power from interfering with each other.

Through the previous design and description, in the present invention, the internal hood 21 of the electric machine set 20 of the hub drive structure is fixed by means of the shaft tube arm 22 to the hub shaft 10, so that when the motor is supplied with electrical power to cause the rotor 27 to drive the hub 70, a firm and sound supporting force may be obtained to effectively increase the initial driving force of the hub so as to reduce unnecessary kinetic loss, and further, the second planetary gear set 40 and the first planetary gear set 30 are arranged in a coaxial manner and the rotor 27 of the electric machine set 20 and the first planetary gear set 30 of the gear set 300 are mounted on the output sleeve 28 in a coaxial manner, and the output sleeve 28 and the hub 70 are freely and coaxially rotatable relative to the internal hood 21, so as to effectively ensure concentricity to thereby improve operation stability and reduce phenomenon of jitter noise, and to further reduce the volume of the hub by means of the gear set 300.

I claim:

1. A hub drive structure, comprising:
a hub shaft;
a hub, which is formed of a first hub casing and a second hub casing that are combinable in an opposite manner to each other and are respectively arranged at two ends of the hub shaft;
an electric machine set, which comprises an internal hood, an external circumference of one side of the internal hood being rotatably mounted on an internal circumference of the first hub casing of the hub, the internal hood being provided, on a center thereof, with a shaft tube arm fixedly mounted to the hub shaft, an internal toothed ring being fixedly mounted on an internal circumference of the internal hood, the electric machine set comprising an output sleeve rotatably mounted on the shaft tube arm of the internal hood, the electric machine set comprising a stator and a rotor, which are opposite to each other, respectively set on the internal circumference of the internal hood and an external circumference of the output sleeve, one end of the output sleeve being formed with a shaft seat step and a wheel seat step, wherein the shaft seat step receives a gear set to mount thereto through a third bearing and the wheel seat step is provided for fixing and driving the gear set;
the gear set, which is mounted on the output sleeve of the electric machine set, the gear set comprising at least one planetary gear set having an external circumference synchronously mating the internal toothed ring of the internal hood, so that the gear set provides a predetermined reduction ratio, one side of the gear set corresponding to and supported on the third bearing of the output sleeve so as to allow the gear set and the electric machine set to operate in a coaxial manner, the gear set being mounted by means of an inner rotor one-way bearing to an internal circumference of the second hub casing of the hub to allow the electric machine set to drive, after speed reduction through the gear set, in a one way manner, the hub to rotate in an advancing direction; and
an outer rotor input set, which comprises an input sleeve, the input sleeve being rotatably mounted on the hub shaft at an outer side of the hub, the input sleeve being correspondingly assembled, by means of an outer rotor one-way bearing, on the hub, so that the input sleeve is drivable by external man power to drive, in a one way manner, the hub to rotate in the advancing direction.

2. The hub drive structure according to claim 1, wherein a circumference of the hub shaft is formed with a toothed section formed of a plurality of axial toothed ribs, an internal circumference of the shaft tube arm being formed with an internal-hole toothed section corresponding to the toothed section, so that the internal hood is set in engagement with and fixed to the hub shaft by means of the shaft tube arm.

3. The hub drive structure according to claim 1, wherein a first bearing is arranged between the internal hood and an internal circumference of the first hub casing of the hub, the hub shaft using a plurality of second bearings on the shaft tube arm of the internal hood to rotatably support the output sleeve, so as to allow the output sleeve and the hub to concentrically and freely rotate relative to the internal hood.

4. The hub drive structure according to claim 1, wherein the first and second hub casings of the hub comprises locking portions combinable with each other, two sides of an external circumference of at least one of the first and second hub casings being provided with spoke mounting portions for mounting bicycle rim spokes.

5. The hub drive structure according to claim 4, wherein an internal circumference of the second hub casing of the hub comprises a bearing mounting portion corresponding to the inner rotor one-way bearing, the second hub casing being provided, at a center thereof, with a central projection having an external circumference on which the gear set arranged inside is mounted, an internal circumference of the central projection receiving an outer rotor one-way bearing of the outer rotor input set to fasten thereto.

6. The hub drive structure according to claim 1, wherein one end of the input sleeve of the outer rotor input set corresponding to the hub is formed with a raised toothed coupling portion that is formed of a plurality of axial toothed ribs for correspondingly mating by the outer rotor one-way bearing.

7. The hub drive structure according to claim 1, wherein the gear set comprises a first planetary gear set and a second planetary gear set, the first planetary gear set comprising a first sun gear mounted on the wheel seat step of the output sleeve, a circumference of the first sun gear being surrounded by and mating with a plurality of first planet gears, each of the first planet gears being rotatably mounted on a first planetary carrier frame, each of the first planet gears rotatably mounted on the first planetary carrier frame synchronously mating with the internal toothed ring, the second planetary gear set comprising a second sun gear mounted on the first planetary carrier frame, the second sun gear being rotatably mounted through a bearing on the hub shaft, a circumference of the second sun gear being surrounded by and mating with a plurality of second planet gears, each of the second planet gears being rotatably mounted on one side of a second planetary carrier frame, each of the second planet gears rotatably mounted on the second planetary carrier frame synchronously mating with the internal toothed ring.

8. The hub drive structure according to claim 7, wherein an internal circumference of the second planetary carrier frame is rotatably mounted through a fourth bearing on the hub, so that the gear set is operable by the electric machine set to rotate in a coaxial manner in the hub.

9. The hub drive structure according to claim 7, wherein a surface of one side of the first planetary carrier frame of the first planetary gear set that corresponds to the second planetary gear set is formed, in a center thereof, with a mounting toothed hole, and the second sun gear of the second planetary gear set comprises a mounting toothed ring corresponding to the mounting toothed hole.

10. The hub drive structure according to claim 1, wherein the hub drive structure is mounted on a frame, the hub shaft comprising a center bore extending in an axial line, one end of the hub shaft being provided with an electric connector for supplying electrical power to the electric machine set and a first mounting block, an opposite end of the hub shaft being fastened with a retaining nut that retains the outer rotor input set, a second mounting block being formed on an outer side of the retaining nut, the frame comprising two bifurcation bars that are opposite to each other, opposite surfaces of the bifurcation bars each forming a mounting trough having an opening facing outwards, the mounting troughs on the two sides being each formed with a corresponding through hole, so that the hub drive structure is arranged to have the first and second mounting blocks on the two ends of the hub shaft to fit into the two opposite mounting troughs, in combination with a quick-release axle penetrating through the center bore of the hub shaft so as to achieve fixedly mounting between the bifurcation bars on the two sides of the frame.

11. The hub drive structure according to claim 10, wherein the electric connector and the first mounting block are arranged as a combination for being commonly fastened to the hub shaft, and the retaining nut and the second mounting block are two separate parts individually fastened to the hub shaft.
